(19) United States
(12) Patent Application Publication
(10) Pub. No.: US 2025/0153073 A1
(43) Pub. Date: May 15, 2025

(54) METHOD FOR PRESSURE EQUALISATION OF SIMULTANEOUSLY OPERATED COLUMNS

(71) Applicant: Dionex Softron GmbH, Germering (DE)

(72) Inventors: Martin Rendl, München (DE); Anne Morgenstern, Gilching (DE)

(21) Appl. No.: 18/942,315

(22) Filed: Nov. 8, 2024

(30) Foreign Application Priority Data
Nov. 10, 2023 (DE) 102023131320.7

(51) Int. Cl. B01D 15/16; B01D 15/18; G01N 30/32; G01N 30/60

(52) U.S. Cl. CPC B01D 15/163; B01D 15/1885; G01N 30/32; G01N 30/6043; G01N 2030/326

(57) ABSTRACT

A method for operating a chromatography system comprises the system assuming a first configuration, wherein a first pump is fluidly connected to a first separation column, and a second pump is fluidly connected to a second separation column. Further the method comprises while in the first configuration the first pump providing a fluid to the first separation column, the second pump providing a fluid to the second separation column, determining a second pump target pressure, determining a first pump target pressure based on the second pump target pressure, and setting the first pump to provide fluid at the first pump target pressure. Furthermore, the method comprises the system switching to a second configuration, wherein the first pump is fluidly connected to the second separation column, while the first pump provides fluid at the first pump target pressure. Additionally disclosed are a respective chromatography system and computer program product.

### CROSS-REFERENCE TO RELATED APPLICATION

This application claims priority from German patent application no. DE 10 2023 131 320.7, filed Nov. 10, 2023. The entire disclosure of DE 10 2023 131 320.7 is incorporated herein by reference.

### FIELD

The present invention generally relates to operation of a chromatography system and is directed at pressure equalization in chromatography applications, particularly pressure equalisation of simultaneously operated separation columns in chromatography applications, such as liquid chromatography (LC) applications.

### BACKGROUND

In chromatography applications the number of samples that can be analysed may oftentimes be limited by the capabilities and numbers of respective chromatography systems. Thus, it may generally be desirable to increase efficiency of the analysis in order to improve usage of available chromatography systems. Therefore, in the field of chromatography, such as liquid chromatography (LC) and particularly in the fields of high performance liquid chromatography (HPLC) and ultra high performance liquid chromatography (UHPLC), there is a demand to increase the throughput of sample analyses to reduce the time to result as well as associated costs.

An established way of improving the throughput of a chromatography system is to employ specifically tailored workflows, such as tandem LC workflows, wherein time-shifted parallel analyses may be possible through using two or more columns in a respective chromatography system. In other words, a higher throughput may be achieved by employing workflows such as tandem LC that allow to parallelize certain steps of the sample analysis. Thus, a plurality of separation columns may be employed in a single HPLC system (e.g., instrumentation).

However, workflows utilizing a plurality of separation columns may typically require switching between the plurality of separation columns for analysis. That is, a separation column may for example be prepared and loaded with a sample and subsequently be switched into an analytical flow path while at the same time another separation column is switched out of the analytical flow path. That is, throughout the workflow fluidic connections of the separation columns to respective pumps may be switched, for example because certain pumps may be designated to certain tasks (e.g., one pump may be dedicated to providing a gradient, while column condition and sample loading may be performed by another pump). Said switching between separation columns may typically occur by means of a column valve. Switching between the separation columns may lead to detrimental effects as the pressures at the different columns may not always match. This may compromise analytical results and lead to a reduction of column lifetime. In other words, in an HPLC application involving a plurality of separation columns (such as tandem LC), a lack of pressure alignment between the separation columns may cause a sudden change in pressure (e.g., a pressure drop or more generally pressure jump) at an inlet of said separation columns upon switching between separation columns, e.g., through switching of a respective column valve.

Such differences in pressure and thus the resulting pressure changes may have a plurality of causes, which may include differences to column backpressures due to different column types, fabrication tolerances and/or aging of columns (e.g., agglomeration of particulates or changes to the column bed), different flow conditions, such as flow rate, solvent composition and/or column temperature, and/or differences in the fluidic flow path. Some of which may be unavoidable even in an otherwise symmetric setup.

Consequently, employing such workflows can bear the risk of impaired quality of analysis and/or reduced column lifetime, which would reduce the benefit of a higher throughput or even render it void. In other words, it may generally be advantageous that the quality of the analysis is at least not significantly compromised in such a workflow scenario.

In light of the above, it is an object to overcome or at least alleviate the shortcomings and disadvantages of the prior art. More particularly, it is an object of the present invention to reduce and ideally prevent a change in pressure when switching between columns.

These objects are met by the present invention.

### SUMMARY

In a first embodiment, the present invention relates to a method for operating a chromatography system, the method comprising the system assuming a first configuration, wherein a first pump is fluidly connected to a first separation column, and a second pump is fluidly connected to a second separation column. Further, the method comprises, in the first configuration, the first pump providing a fluid to the first separation column, the second pump providing a fluid to the second separation column, determining a second pump target pressure (P_{target,eq}), determining a first pump target pressure (P_{target,grad}) based on the second pump target pressure (P_{target,eq}), and setting the first pump to provide fluid at the first pump target pressure (P_{target,grad}). The method further comprises the system switching to a second configuration, wherein the first pump is fluidly connected to the second separation column, while the first pump provides fluid at the first pump target pressure (P_{target,grad}).

That is, the present invention relates to a method wherein a chromatography system assumes a first configuration, wherein a first pump is connected to a first separation column and a second column is connected to a second separation column. Further, the method comprises determining a second pump target pressure and based thereon a first pump target pressure to which the first pump is set, all of which while the system being in this first configuration. Subsequently the system switches to a second configuration wherein the first pump provides fluid at the first pump target pressure to the second configuration column. This may advantageously allow to determine the second pump target pressure preferably such that pressure fluctuations at the second separation column (and preferably the first separation column) can be avoided when the system switches into the second configuration.

The second pump target pressure may be determined based on a desired flow rate. Such a desired flow rate may be a gradient flow rate, i.e., a flow rate for running a gradient for sample analysis. The method may further comprise the first pump providing fluid to the second separation column at the desired flow rate in the second configuration. That is, the first pump providing fluid at the first pump target pressure to the second separation column may correspond to the first pump providing fluid at the desired flow rate. This may be achieved by determining the second pump target pressure based on the desired flow rate and subsequently determining the first pump target pressure based on the second pump target pressure. For example, the second pump target pressure may be determined such that in the first configuration the second pump supplies a fluid across the second separation column at the desired flow rate when the second pump target pressure is present at the second pump.

Determining the second pump target pressure may comprise calculating a target pressure. Further, calculating the target pressure may comprise determining a second pump backpressure originating from the second separation column and a fluidic path between an outlet of the second pump and an inlet of the second separation column. In other words, a backpressure caused by the second separation column and the fluidic path between the second pump and the second separation column may be determined. Determining the second pump backpressure may be based on a pressure at the second pump and a flow rate of a fluid delivered at this pressure to the second separation column. For example, the second pump backpressure may be for example be determined by measuring pressure and flow rate at which a fluid is delivered to the second separation column by the second pump. The second pump backpressure may then by given by the ratio of pressure and flow. Calculating the target pressure may be based on the second pump backpressure and the desired flow rate. Generally, the target pressure may be calculated as the product of the second pump backpressure and the desired flow rate. The second pump target pressure may be determined to correspond to the target pressure.

The method may further comprise setting the second pump to provide fluid at the second pump target pressure in the first configuration. Thus, the method may comprise the second pump providing fluid to the second separation column at the second pump target pressure in the first configuration. Setting the second pump to provide fluid at the second pump target pressure in the first configuration may comprise operating the second pump in a flow-controlled mode and setting the flow to the desired flow rate. Alternatively, setting the second pump to provide fluid at the second pump target pressure in the first configuration may comprise operating the second pump in a pressure-controlled mode and setting it to the target pressure. In such a case, the method may comprise operating the second pump in a flow-controlled mode once the target pressure has been reached, wherein the second pump is set to provide the desired flow rate. That is, the second pump may initially be operating in a pressure-controlled mode with the aim to provide fluid at the target pressure and once the target pressure has been reached, the pump may be changed to provide fluid at the desired flow rate. This may advantageously be faster than simply operating the second pump in a flow-controlled mode and waiting until the desired flow rate has been reached.

The step of setting the first pump to provide fluid at the first pump target pressure may be performed after the step of setting the second pump to provide fluid at the second pump target pressure. Determining the second pump target pressure may comprise measuring the pressure present at the second pump when providing the desired flow rate, wherein the second pump target pressure is determined to correspond to the measured pressure. Measuring the pressure present at the second pump when providing the desired flow rate may advantageously be more precise than simply calculating it. That is, while the second pump target pressure could simply be derived from the calculated target pressure, it may be advantageous to rather use the target pressure for setting the second pump to the desired flow rate, which may be faster using pressure-controlled operation of the second pump, and to then measure the actual pressure present at the second pump when supplying fluid to the second separation column at the desired flow rate, as it may lead to more accurate results.

Determining the first pump target pressure may further based on a fluidic resistance of a fluidic connection downstream of the second pump that is independent of whether the system is in the first or second configuration. In other words, determining the first pump target pressure may further be based on the fluidic resistance of the fluidic connection that is unique to the second pump. This may advantageously allow to account for differences in fluidic resistance between the fluidic connection of the second pump to the second separation column in the first configuration and the fluidic connection of the first pump to the second separation column in the second configuration.

In some embodiments, the first pump target pressure may be determined as a difference of the second pump target pressure and a backpressure originating from the fluidic connection downstream of the second pump that is independent of whether the system is in the first or second configuration. It will be understood that this may only be an approximation as the fluidic resistance of the fluidic connection unique to the first pump is not considered, however its contribution may typically be negligible. Alternatively, the fluidic resistance of the fluidic connection unique to the first pump may be added accordingly. More generally, determining the first pump target pressure may further be based on a fluidic resistance of a fluidic connection downstream of the first pump that is independent of whether the system is in the first or second configuration.

In some embodiments, determining the first pump target pressure may further be based on a difference in fluidic resistance between a fluidic connection of the second pump to the second separation column in the first configuration, and a fluidic connection of the first pump to the second separation column in the second configuration. This may basically correspond to taking into account the fluidic resistance of the fluidic connections of both, the first and the second pump.

The first pump target pressure may be determined such that when the first pump target pressure is present at the first pump while providing a fluid to the second separation column, a pressure at an inlet of the second separation column is substantially equal to the pressure at the inlet of the second separation column when supplying the same fluid with the second pump at the second pump target pressure. Thus, pressure jumps may advantageously be avoided when switching from the first configuration to the second configuration or vice versa.

The term substantially generally serves to include deviations due to measurement tolerances of respective pressure sensors, as well as manufacturing tolerances of system components such as fluidic conduits, pumps, separation columns, sensors and valves, which may for example result in slight deviations of pressure and/or fluid composition.

When the first pump target pressure is present at the first pump while providing a fluid to the second separation column, the pressure at the inlet of the second separation column may be substantially equal to the pressure at the inlet of the second separation column when supplying the same fluid with the second pump at the second pump target pressure.

The second pump target pressure may be determined for a desired fluid composition. The desired fluid composition may preferably correspond to a gradient start composition, i.e., a solvent composition for starting a gradient. The second pump backpressure may be determined for the desired fluid composition. The fluid delivered when determining the backpressure may comprise the desired fluid composition. The first pump and the second pump may both supply a fluid with the desired fluid composition when switching from the first to the second configuration. This may advantageously enable to directly start with running the gradient upon switching from the first configuration to the second configuration without any substantial pressure jumps.

The method may further comprise the first pump supplying a fluid at the first pump target pressure and the second pump supplying a fluid at the second pump target pressure immediately prior to the system switching from the first to the second configuration.

The method may further comprise operating the first pump in a flow-controlled mode at the time when the system switches from the first configuration to the second configuration.

The second pump may provide fluid at the desired flow rate immediately prior to the system switching from the first to the second configuration.

The method may further comprise the first pump providing a fluid with the desired fluid composition to the first separation column when setting the first pump to provide fluid at the first pump target pressure.

The method may further comprise the first pump providing a gradient to the first separation column in the first configuration. Additionally or alternatively, the method may further comprise the first pump providing a gradient to the second separation column in the second configuration. In such cases, the desired fluid composition my correspond to the starting solvent composition for the gradient.

The method further may further comprise the second pump providing a washing fluid to the second separation column in the first configuration. Additionally or alternatively, the method may further comprise the second pump providing an equilibration fluid to the second separation column in the first configuration. When providing both, the equilibration fluid may be provided after the washing fluid. The equilibration fluid may comprise the desired fluid composition.

The method may further comprise injecting a sample into a flow path between the second pump and the second separation column in the first configuration. Additionally, the method may comprise the second pump providing a loading fluid to the second separation column in the first configuration. The loading fluid may comprise the desired fluid composition. The loading fluid may be provided after the equilibration fluid. The fluid delivered when determining the second pump backpressure may be the loading fluid.

A relative pressure change at the inlet of the second separation column when the system switches from the first to the second configuration may be less than 10%, preferably less than 5% more preferably less than 1%. Additionally or alternatively, a relative flow change at the inlet of the second separation column when the system switches from the first to the second configuration is less than 10%, preferably less than 5% more preferably less than 1%.

The desired flow rate may be within the range of 0 to 100 μL/min. The first pump target pressure is within the range of range of 50 to 1500 bar. The second pump target pressure is within the range of range of 50 to 1500 bar.

In the second configuration, the second pump may be fluidly connected to the first separation column, while the second pump provides fluid at the second pump target pressure.

In another embodiment, the present invention relates to a computer program product comprising instructions which, when the program is executed by a computer, cause the computer to carry out the method as described above

In yet another embodiment, the present invention relates to a chromatography system comprising a first pump, a second pump, a first separation column, and a second separation column, wherein the system is configured to assume a first configuration, wherein the first pump is fluidly connected to the first separation column, and the second pump is fluidly connected to the second separation column. Further the system is configured to assume a second configuration wherein the first pump is fluidly connected to the second separation column, and wherein the system further comprises a controller configured to perform the method as described above.

The system may further comprise a column distribution valve fluidly connected to the first pump, the second pump, the first separation column and the second separation column and configured to enable switching the system between the first and second configuration.

The system may further comprise an autosampler configured to pick up and inject a sample. The autosampler may be fluidly connected to the first pump. If present, the autosampler may be fluidly connected to the column distribution valve, wherein the autosampler is downstream of the first separation column and upstream of the column distribution valve.

The first pump may be a gradient pump, configured to provide a solvent gradient to a fluidly connected separation column. The second pump may be an equilibration pump configured to provide fluids for washing, equilibrating and/or loading of a fluidly connected separation column.

The system may be a liquid chromatography system. Further, the system may be a high-performance liquid chromatography system. In some embodiments, the system may be an ultra high performance liquid chromatography system.

The system may be configured for tandem chromatography. That is, the system may be configured to perform tandem workflows, wherein throughput and detector utilization may be increased through switching between columns and running column equilibration on one column in parallel with sample separation on another column.

The first pump may be configured to provide pressures of at least up to 50 bar, preferably at least up to 100 bar, more preferably at least up to 500, such as up to 1500 bar.

In the second configuration, the second pump may be fluidly connected to the first separation column.

The chromatography system of the method as previously described may be a chromatography system according as described above.

Below, reference will be made to method embodiments. These embodiments are abbreviated by the letter “M” followed by a number. Whenever reference is herein made to “method embodiments”, these embodiments are meant.

M1. A method for operating a chromatography system, the method comprising
the system assuming a first configuration, wherein
   a first pump is fluidly connected to a first separation column;
   a second pump is fluidly connected to a second separation column;
in the first configuration:
   the first pump providing a fluid to the first separation column;
   the second pump providing a fluid to the second separation column;
   determining a second pump target pressure (P_{target,eq});
   determining a first pump target pressure (P_{target,grad}) based on the second pump target pressure (P_{target,eq}); and
   setting the first pump to provide fluid at the first pump target pressure (P_{target,grad});
the method further comprising:
the system switching to a second configuration, wherein the first pump is fluidly connected to the second separation column, while the first pump provides fluid at the first pump target pressure (P_{target,grad}).

M2. The method according to the preceding embodiment, wherein the second pump target pressure is determined based on a desired flow rate.

M3. The method according to the preceding method embodiment, wherein the method further comprises

the first pump providing fluid to the second separation column at the desired flow rate in the second configuration.

M4. The method according to any of the two preceding method embodiments, wherein the second pump target pressure is determined such that in the first configuration the second pump supplies a fluid across the second separation column at the desired flow rate when the second pump target pressure is present at the second pump.

M5. The method according to any of the preceding method embodiments, wherein determining the second pump target pressure comprises calculating a target pressure.

M6. The method according to the preceding method embodiment, wherein calculating the target pressure comprises determining a second pump backpressure originating from the second separation column and a fluidic path between an outlet of the second pump and an inlet of the second separation column.

M7. The method according to the preceding method embodiment, wherein determining the second pump backpressure is based on a pressure at the second pump and a flow rate of a fluid delivered at this pressure to the second separation column.

M8. The method according to any of the two preceding method embodiments and with the features of M2, wherein calculating the target pressure is based on the second pump backpressure and the desired flow rate.

M9. The method according to any of the three preceding method embodiments and with the features of M2, wherein the target pressure is calculated as the product of the second pump backpressure and the desired flow rate.

M10. The method according to any of the five preceding method embodiments, wherein the second pump target pressure is determined to correspond to the target pressure.

M11. The method according to any of the preceding method embodiments, wherein the method further comprises setting the second pump to provide fluid at the second pump target pressure in the first configuration.

M12. The method according to the preceding method embodiment and with the features of M2, wherein setting the second pump to provide fluid at the second pump target pressure in the first configuration comprises operating the second pump in a flow-controlled mode and setting the flow to the desired flow rate

M13. The method according to the penultimate method embodiment and with the features of M5, wherein setting the second pump to provide fluid at the second pump target pressure in the first configuration comprises operating the second pump in a pressure-controlled mode and setting it to the target pressure.

M14. The method according to the preceding method embodiment and with the features of M2, wherein the method comprises operating the second pump in a flow-controlled mode once the target pressure has been reached, wherein the second pump is set to provide the desired flow rate.

M15. The method according to any of the four preceding method embodiments, wherein the step of setting the first pump to provide fluid at the first pump target pressure is performed after the step of setting the second pump to provide fluid at the second pump target pressure.

M16. The method according to any of the preceding method embodiments and with the features of M2, wherein determining the second pump target pressure comprises measuring the pressure present at the second pump when providing the desired flow rate, wherein the second pump target pressure is determined to correspond to the measured pressure.

M17. The method according to any of the preceding method embodiments, wherein determining the first pump target pressure is further based on a fluidic resistance of a fluidic connection downstream of the second pump that is independent of whether the system is in the first or second configuration.

M18. The method according to any of the preceding method embodiments, wherein the first pump target pressure is determined as a difference of the second pump target pressure and a backpressure originating from the fluidic connection downstream of the second pump that is independent of whether the system is in the first or second configuration.

M19. The method according to any of the preceding method embodiments, wherein determining the first pump target pressure is further based on a difference in fluidic resistance between a fluidic connection of the second pump to the second separation column in the first configuration, and a fluidic connection of the first pump to the second separation column in the second configuration.

M20. The method according to any of the preceding method embodiments, wherein determining the first pump target pressure is further based on a fluidic resistance of a fluidic connection downstream of the first pump that is independent of whether the system is in the first or second configuration.

M21. The method according to any of the preceding method embodiments, wherein the first pump target pressure is determined such that when the first pump target pressure is present at the first pump while providing a fluid to the second separation column, a pressure at an inlet of the second separation column is substantially equal to the pressure at the inlet of the second separation column when supplying the same fluid with the second pump at the second pump target pressure.

The term substantially generally serves to include deviations due to measurement tolerances of respective pressure sensors, as well as manufacturing tolerances of system components such as fluidic conduits, pumps, separation columns, sensors and valves, which may for example result in slight deviations of pressure and/or fluid composition.

M22. The method according to any of the preceding method embodiments, wherein, when the first pump target pressure is present at the first pump while providing a fluid to the second separation column, the pressure at the inlet of the second separation column is substantially equal to the pressure at the inlet of the second separation column when supplying the same fluid with the second pump at the second pump target pressure.

M23. The method according to any of the preceding method embodiments, wherein the second pump target pressure is determined for a desired fluid composition.

M24. The method according to the preceding method embodiment and with the features of M5, wherein the second pump backpressure is determined for the desired fluid composition.

M25. The method according to any of the two preceding method embodiments and with the features of M7, wherein the fluid delivered when determining the backpressure comprises the desired fluid composition.

M26. The method according to any of the preceding method embodiments, wherein when switching from the first to the second configuration the first pump and the second pump both supply a fluid with the desired fluid composition.

M27. The method according to any of the preceding method embodiments, wherein the method further comprises the first pump supplying a fluid at the first pump target pressure and the second pump supplying a fluid at the second pump target pressure immediately prior to the system switching from the first to the second configuration.

M28. The method according to any of the preceding method embodiments, wherein the method further comprises operating the first pump in a flow-controlled mode at the time when the system switches from the first configuration to the second configuration.

M29. The method according to any of the preceding method embodiments and with the features of M2, wherein the second pump provides fluid at the desired flow rate immediately prior to the system switching from the first to the second configuration.

M30. The method according to any of the preceding method embodiments and with the features of M23, wherein the method further comprises the first pump providing a fluid with the desired fluid composition to the first separation column when setting the first pump to provide fluid at the first pump target pressure.

M31. The method according to any of the preceding method embodiments, wherein the method further comprises the first pump providing a gradient to the first separation column in the first configuration.

M32. The method according to any of the preceding method embodiments, wherein the method further comprises the first pump providing a gradient to the second separation column in the second configuration.

M33. The method according to any of the two preceding method embodiments and with the features of M23, wherein the desired fluid composition corresponds to the starting solvent composition for the gradient.

M34. The method according to any of the preceding method embodiments, wherein the method further comprises the second pump providing a washing fluid to the second separation column in the first configuration.

M35. The method according to any of the preceding method embodiments, wherein the method further comprises the second pump providing an equilibration fluid to the second separation column in the first configuration.

M36. The method according to the preceding method embodiment and with the features of the penultimate embodiment, wherein the equilibration fluid is provided after the washing fluid.

M37. The method according to any of the two preceding method embodiments and with the features of M23, wherein the equilibration fluid comprises the desired fluid composition.

M38. The method according to any of the preceding method embodiments, wherein the method further comprises injecting a sample into a flow path between the second pump and the second separation column in the first configuration.

M39. The method according to the preceding method embodiment, wherein the method further comprises the second pump providing a loading fluid to the second separation column in the first configuration.

M40. The method according to the preceding method embodiment and with the features of M23, wherein the loading fluid comprises the desired fluid composition.

M41. The method according to any of the two preceding method embodiments and with the features of M35, wherein the loading fluid is provided after the equilibration fluid.

M42. The method according to any of the three preceding method embodiments and with the features of M6, wherein the fluid delivered when determining the second pump backpressure is the loading fluid.

M43. The method according to any of the preceding method embodiments, wherein a relative pressure change at the inlet of the second separation column when the system switches from the first to the second configuration is less than 10%, preferably less than 5% more preferably less than 1%.

M44. The method according to any of the preceding method embodiments, wherein a relative flow change at the inlet of the second separation column when the system switches from the first to the second configuration is less than 10%, preferably less than 5% more preferably less than 1%.

M45. The method according to any of the preceding method embodiments and with the features of M2, wherein the desired flow rate is within the range of 0 to 100 μL/min.

M46. The method according to any of the preceding method embodiments, wherein the first pump target pressure is within the range of 50 to 1500 bar.

M47. The method according to any of the preceding method embodiments, wherein the second pump target pressure is within the range of 50 to 1500 bar.

M48. The method according to any of the preceding method embodiments, wherein in the second configuration the second pump is fluidly connected to the first separation column, while the second pump provides fluid at the second pump target pressure.

Below, reference will be made to computer program product embodiments. These embodiments are abbreviated by the letter “P” followed by a number. Whenever reference is herein made to “program embodiments”, these embodiments are meant.

P1. A computer program product comprising instructions which, when the program is executed by a computer, cause the computer to carry out the method according to any of the preceding method embodiments.

Below, reference will be made to chromatography system embodiments. These embodiments are abbreviated by the letter “S” followed by a number. Whenever reference is herein made to “system embodiments”, these embodiments are meant.

S1. A chromatography system, comprising
a first pump;
a second pump;
a first separation column;
a second separation column;
wherein the system is configured to assume a first configuration, wherein
   the first pump is fluidly connected to the first separation column; and
   the second pump is fluidly connected to the second separation column;
wherein the system is configured to assume a second configuration wherein the first pump is fluidly connected to the second separation column; and
wherein the system further comprises a controller configured to perform the method according to any of the preceding method embodiments.

S2. The system according to the preceding system embodiment, wherein the system further comprises a column distribution valve fluidly connected to the first pump, the second pump, the first separation column and the second separation column and configured to enable switching the system between the first and second configuration.

S3. The system according to any of the preceding system embodiments, wherein the system further comprises an autosampler configured to pick up and inject a sample.

S4. The system according to the preceding system embodiment, wherein the autosampler is fluidly connected to the first pump.

S5. The system according to the preceding system embodiment and with the features of S2, wherein the autosampler is further fluidly connected to the column distribution valve, wherein the autosampler is downstream of the first separation column and upstream of the column distribution valve.

S6. The system according to any of the preceding system embodiments, wherein the first pump is a gradient pump, configured to provide a solvent gradient to a fluidly connected separation column.

S7. The system according to any of the preceding system embodiments, wherein the second pump is an equilibration pump configured to provide fluids for washing, equilibrating and/or loading of a fluidly connected separation column.

S8. The system according to any of the preceding system embodiments, wherein the system is a liquid chromatography system.

S9. The system according to any of the preceding system embodiments, wherein the system is a high-performance liquid chromatography system.

S10. The system according to any of the preceding system embodiments, wherein the system is an ultra high performance liquid chromatography system.

S11. The system according to any of the preceding system embodiments, wherein the system is configured for tandem chromatography.

That is, the system may be configured to perform tandem workflows, wherein throughput and detector utilization may be increased through switching between columns and running column equilibration on one column in parallel with sample separation on another column.

S12. The system according to any of the preceding system embodiments, wherein the first pump is configured to provide pressures of at least up to 50 bar, preferably at least up to 100 bar, more preferably at least up to 500, such as up to 1500 bar.

S13. The system according to any of the preceding system embodiments, wherein in the second configuration the second pump is fluidly connected to the first separation column.

M49. The method according to any of the preceding method embodiments, wherein the chromatography system is a chromatography system according to any of the preceding system embodiments.

Embodiments of the present invention will now be described with reference to the accompanying drawings. These embodiments should only exemplify, but not limit, the present invention.

### BRIEF DESCRIPTION OF THE DRAWINGS

FIG. 1 depicts an exemplary tandem chromatography system.

FIG. 2 depicts an exemplary tandem workflow.

FIGS. 3A-3F depict a schematic illustration of pump signals during a sample run.

FIG. 4 depicts a method according to the present invention.

FIGS. 5A-5B depict exemplary total-ion-current chromatography showcasing an impact of pressure changes on the analytical result.

### DETAILED DESCRIPTION

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

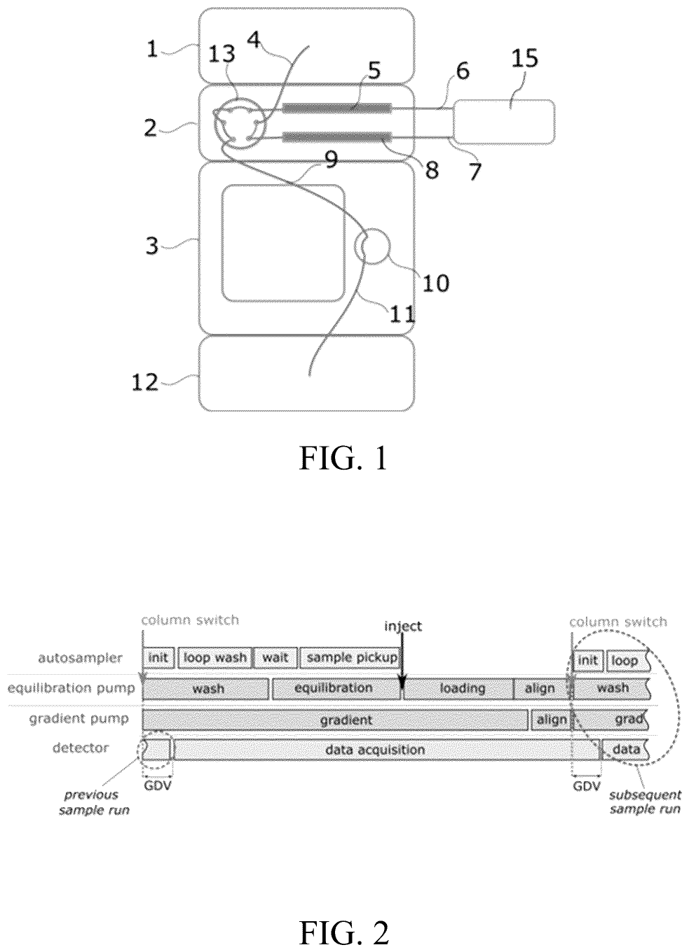

Reference will now be made to FIG. 1 depicting an exemplary chromatography system in a tandem configuration. Very generally such a system may comprise two pumps 1, 12, which may be referred to as first pump 1 and second pump 12, an autosampler 3 comprising an injection valve 10, a column compartment 2, comprising a distribution valve 13 (also referred to as column switching valve 13) and two separation columns 5, 8, which may be referred to as first separation column 8 and second separation column 5, as well as respective fluidic connections 4, 6, 7, 9, 11. The separation columns 5, 8 may be fluidly connected to at least one detector 15, wherein in the case of a single detector, typically only one of the separation columns 5, 8 may be connected to the detector 15 at the same time, e.g., through employment of a respective valve selectively connecting one of the separation columns to the detector. In such a case, the other separation column may for example be fluidly connected to waste. In some embodiments each separation column 5, 8 may be fluidly connected to a separate detector 15, wherein it may again be possible to alternatively fluidly connect the separation pump to waste, e.g., when washing the column.

The pumps 1, 12 may generally be configured to supply fluids and particularly solvents at a desired flow rate and/or pressure. For LC and particularly (U) HPLC applications these pumps may be high-pressure pumps capable of providing fluids at a pressure of at least 50 bar, preferably at least 100 bar, more preferably at least 500 bar, such as at least 1000 bar, e.g., up to 1500 bar.

The first pump 1 may be configured to provide a solvent gradient to a selected separation column 5, 8 for sample analysis. Thus, the first pump 1 may also be referred to as gradient pump 1. The second pump 12 may be configured to provide fluid for column equilibration as well as fluid for washing and/or loading a respective column 5, 8. Thus, the second pump 12 may be referred to as equilibration pump 12.

The autosampler 3 may generally be configured to pick up a sample and may typically comprise a sampling device (also referred to as metering device), e.g., an automated syringe and a sample pick-up means, which may typically be a needle fluidly connected to the sampling device. Furthermore, the autosampler 3 may comprise a seat configured to receive the sample-pick up means, and a sample storage portion, e.g., a sample loop. This may allow the autosampler 3 to pick up a sample by placing the sample pick-up means in a sample vial and drawing sample from the sample vial into the sample storage portion by means of the sampling device. Typically, sample storage, sampling device, sample pick-up means and seat are fluidly connected to the injection valve 10, which may particularly allow to switch the sample storage portion into the fluidic path between equilibration pump 12 and column compartment 2.

The column compartment 2 may be configured to hold a plurality of separation columns 5, 8. In some embodiments the column compartment 2 may further be configured to provide temperature control for the plurality of separation columns, i.e., the column compartment 2 may be configured to provide a designated temperature to the plurality of columns either individually or for all of them together.

The separation columns 5, 8 may be identical or different, and generally configured to separate a sample through chromatographic separation. That is, the separation columns 5, 8 may comprise a solid phase, e.g., an adsorbent, which may interact with components of a mobile phase (particularly constituents of the sample) passing through the separation column, thereby separating different compounds of the mobile phase due to their different interaction with the adsorbent resulting in characteristic retention times that may be measured in a subsequent detector 15.

The column distribution valve 13 may be a distribution valve configured to switch fluidic connections between the pumps 1, 12 and the separation columns 5, 8. In the depicted analytical setup, the column distribution valve 13 may always fluidically connect the gradient pump 1 to one separation column (e.g., the first separation column 8 as depicted) and the autosampler 3 (and thereby typically the equilibration pump 12) to the other separation column (in the depicted configuration the second separation column 5).

The fluidic connections 4, 6, 7, 9, 11 may typically be fluidic conduits such as capillaries, which may for example be connected to system components via respective fittings.

The at least one detector 15 may generally be configured to provide a time-resolved measurement of constituents arriving at the detector 15 thus allowing to determine the respective retention time. Such a detector 15 may for example be a mass spectrometer (MS) (e.g., inductively coupled plasma mass spectrometer (ICP-MS)), a fluorescence detector, charged aerosol detector (CAD), a refractive-index detector, absorbance detectors etc.

Thus, the chromatography system may generally be configured to assume at least a first configuration wherein the first pump 1 is fluidly connected to the first separation column 8 and the second pump is fluidly connected to the second separation column 5 (depicted in FIG. 1) and a second configuration, wherein the first pump 1 is fluidly connected to the second separation column 5. Switching between these configurations may be achieved by means of the column distribution valve 13. Preferably, the second pump 12 may be fluidly connected to the first separation column 8 in the second configuration.

With reference to FIG. 2 an exemplary tandem workflow for a chromatography system such as the one described above with reference to FIG. 1 is discussed. The workflow may be broken down in several subroutines, which are depicted as individual items or building blocks relating to certain tasks during the workflow. A lateral extension of the respective items along a horizontal axis may be indicative of the duration of the respective subroutines and a position of the item with respect to the horizontal axis may further be indicative of the timing of the respective subroutine. That is, generally the horizontal axis may indicate a time. The vertical position of an item may be indicative of its association to a component of the chromatography system. That is, the tandem workflow advantageously allows to perform certain subroutines simultaneously by different system components. It will be understood that the schematic illustration in FIG. 2 is a simplification and that for example details such as switching of certain valves (e.g., column distribution valve 13 and/or injection valve 10) are not included in this illustration.

As indicated, the leftmost point of the horizontal axis corresponds to a time of a column switch, i.e., a switching of column distribution valve 13 resulting in a change in configuration with respect to which pump 1, 12 is providing a fluid flow to which separation column 5, 8. For example, the chromatography system may at this time assume the first configuration as depicted in FIG. 1.

Thus, the equilibration pump 12 may be fluidly connected to the second separation column 5, while the gradient pump 1 may be fluidly connected to the first separation column 8. The equilibration pump 12 may wash (wash) and subsequently equilibrate (equilibration) the second separation column 5, while the autosampler 3 may at the same time initialize (init), wash the sample loop (loop wash), optionally wait (wait) and pick up the sample (sample pickup). The waiting may serve align sample pickup and equilibration such that both end at substantially the same time in order to then inject the sample, e.g., through switching the sample loop into the flow path between equilibration 12 pump and separation column 5. The term substantially serves to include deviations due to manufacturing tolerances and measurement uncertainties. The equilibration pump 12 may then supply a fluid for loading the sample onto the second separation column 5 (loading).

In parallel, the gradient pump 1 may supply a respective gradient to the first separation column 8 (gradient) and the detector 15 may detect constituents of the respective effluent and acquire associated data (data acquisition). The measurement and data acquisition of the detector 15 may be shifted with respect to the gradient supplied by the gradient pump 1 by the gradient delay volume (GDV). That is the starting point (horizontal position) of the data acquisition subroutine may be delayed with respect to the starting point of the gradient subroutine to account for the GDV, i.e., the volume between mixing of the mobile phase and inlet of the separation column 8.

Both, equilibration pump 12 and gradient pump 1 may perform an align subroutine which may serve to align operation of both pumps prior to the next column switch, which will alter the configuration of the chromatography system such that now the equilibration pump 12 is fluidly connected to the first separation column 8 previously connected to the gradient pump 1 and vice versa. This allows for the loaded sample to be analysed with a gradient provided by the gradient pump 1, while autosampler 3 and equilibration pump 12 may condition and load the first separation column 8 with the next sample. According to the present invention, the align subroutine may additionally or alternatively serve for aligning pressures prior to switching between columns.

When utilizing such a tandem setup for measuring chromatograms providing respective retention times for different constituents of a mobile phase and particularly the sample, certain problems may arise if the pressures at the separation columns do not match. Under ideal conditions (i.e., both pumps and fluid pathways are identical) and constant flow conditions (i.e., all operations are performed at gradient flow rate without any flow changes) and in the case of a symmetrical column configuration (i.e., columns having identical backpressures) there would be no difference in the retention times in the chromatograms for both separation columns. However, a difference in backpressure between the separation columns, which may exist even under identical flow conditions (constant, same solvent composition), would already result in a pressure difference between the two columns 5, 8. That is a different pressure would be present at the inlet of the respective separation columns 5,8. Such difference in backpressure may frequently occur in typical (U) HPLC applications originating from aging columns e.g., through agglomeration of particles, changes to the column packing and/or from the sample.

Such a pressure difference may effectively result in a sudden change in pressure (e.g., pressure drop or more generally pressure jump) upon switching the gradient pump 1 from one column to another. The pressure change may be positive or negative. In either case, and depending on the magnitude of the pressure change, the flow rate and solvent composition during the early phase of the gradient may be negatively affected. Particularly, the pressure change may disturb the flow control of the pump, which may result in incorrect solvent composition and/or total flow rate. Additionally, the pressure change may result in a flow error of the total flow rate originating from a flow contribution from compression (negative pressure change) or relaxation (positive pressure change) of the liquid. Thus, the respective flow error may be proportional to the pressure change. More precisely, the flow error may be dependent on a volume (of the conduit) that is affected by the pressure change, a compressibility of the solvent within the conduit, a backpressure of the fluid path where relaxation or compression originates as well as the magnitude of the pressure change. As a result, the quality of analytical result, i.e., the chromatogram, may be compromised due to wash-off und thus missing of (early-eluting) compounds.

Again, such pressure changes that appear when switching the column valve 13, i.e., when changing which pump is fluidly connected to which separation column. Thus, each column may experience a pressure change, wherein the magnitude of the pressure change depends on the relative pressure difference between the columns. Generally, the pressure change may originate due to at least one or a combination of the following causes: a difference in column backpressure and thus fluidic resistance, a difference in flow conditions and/or a difference in fluidic flow paths of the columns.

The difference in column backpressure between the separation columns may for example be due to the columns being of different type, e.g., comprising different dimensions, and/or comprising a different stationary phase (i.e., adsorbent), additionally or alternatively a difference in backpressure may arise from fabrication tolerances during the manufacturing process of the columns and/or due to aging of the columns. Aging may for example comprise agglomeration of particulars within the column or changes to the column bed, e.g., loss of stationary phase and/or alteration of the stationary phase for example through rearrangement of the stationary phase. The latter may mainly appear in case of packed columns, i.e., columns filled with beads, while monolithic columns would for example not be affected by alteration of the stationary phase. However, for any type of column the lifetime may be compromised by mechanical stress induced by pressure jumps. Here the term column bed refers to constituents of a pack column, e.g., beads, whereas the term stationary phase may generally refer to any solid matter of a column to which a compound in solution may bind or respectively interact with. Thus, column bed may only be relevant to packed columns, while stationary phase also includes materials of monolithic column.

The difference in flow conditions may for example comprise a different flow rate, a different solvent composition and/or a different column temperature. That is, generally this may be due to operating the separation columns at different conditions, particularly flow conditions, which may influence the fluid flow through the respective separation column.

The difference between the fluidic flow paths of the columns may for example comprise different length of fluidic conduits between a respective pump and the column, different diameters of the fluidic conduits, etc. Such a difference may for example be necessitated by constructive limitations to the arrangement of components within the system.

Consequently, it may be at least desirable if not necessary to reduce and ideally prevent respective pressure changes when switching between separation columns, particularly at the separation column subsequently subjected to a gradient, i.e., the column connected to the gradient pump during switching. Thus, the present invention aims to provide a method that enables reduction and potentially even prevention of such pressure changes by carefully aligning the pumps and particularly their pressures and/or flow rates prior to switching between separation columns.

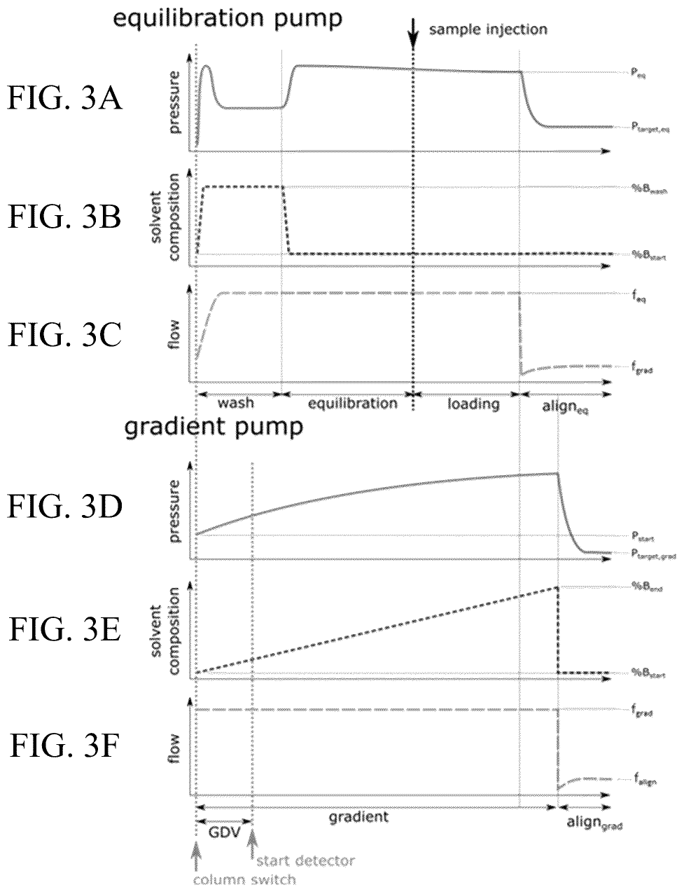

Thus, the present method comprises pressure alignment between a plurality of pumps. Further to FIG. 2, FIGS. 3A-3F depict pressure, solvent composition, and flow for equilibration pump 12 and gradient pump 1 during the workflow depicted in FIG. 2. It is noted that FIGS. 3A-3F comprise different scales on the y-axis and only illustrate relative changes of pressure, solvent composition and flow within each of the FIGS. 3A-3F. That is, for example, flows of FIG. 3C cannot readily be compared to flows of FIG. 3F since the y-axis may comprise a different scale.

As discussed above, the equilibration pump 12 may perform subroutines relating to column washing, column equilibration and loading of the sample to the separation column (also referred to as analytical column). To enhance throughput, those subroutines (also referred to as steps) may be performed at a higher flow rate with respect to the gradient flow rate f_{grad}. That is, the equilibration flow rate f_{eq} may be higher than the gradient flow rate, f_{eq}>f_{grad} (see FIG. 3C).

As a result, the pressure during this phase may be significantly higher (up to several hundred bar) than the pressure during the initial phase of the gradient Pₛₜₐᵣₜ (see FIG. 3A). In other words, the pressure during wash, equilibration and loading subroutines may be higher than the gradient pressure at the start of the gradient, also referred to gradient start pressure Pₛₜₐᵣₜ. This pressure difference is one of the origins of a pressure change upon switching between separation columns. Thus, the aim of the present invention is to reduce, preferably minimize or even avoid any such a pressure difference.

In order to prepare a separation column 5, 8 for a subsequent gradient subroutine, the pressure of said separation column 5, 8 may be adjusted to match gradient start conditions, particularly the gradient start pressure Pₛₜₐᵣₜ for the respective column. That is, the gradient start pressure Pₛₜₐᵣₜ may be different for the two separation columns. This may occur during a pressure alignment subroutine align_{eq} and can be achieved by adjusting the pump flow to the gradient flow rate f_{grad}. That is, the equilibration pump 12 may be operated in a flow-controlled mode and set to provide the desired gradient flow rate f_{grad}. However, particularly in the case of long separation columns with small particles and small diameter (e.g. fluidic resistance (backpressure)>200 bar per 1 μL/min flow), such an adjustment may consume significant time until the respective target pressure P_{target,eq} is reached due to the rather large fluidic resistance of such columns. P_{target,eq} represents the pressure at the column for steady flow conditions at gradient start conditions (i.e., solvent composition and flow rate (and column temperature) for the start of the gradient).

A significantly faster adjustment of the pressure can be achieved by switching the equilibration pump 12 to a pressure-controlled mode for the adjustment. For this, P_{target,eq} is determined in the first place. It can be obtained by determining the fluidic resistance (backpressure) of the column R_{eq} as P_{target,eq}=R_{eq}*f_{grad}, where R_{eq}=P_{eq}/f_{eq}. It should be denoted that P_{target,eq} is only determined sufficiently correct if the solvent composition at the point when R_{eq} is determined is (nearly) identical to the gradient start solvent composition % Bₛₜₐᵣₜ. Once, P_{target,eq} has been reached the pump may switch again to a flow-controlled mode to deliver the gradient flow rate f_{grad} and the gradient start solvent composition % Bₛₜₐᵣₜ (see FIGS. 3A-3F).

Simultaneously to the pressure alignment (phase align_{eq}—see FIGS. 3A-3F) the sample may still be loaded onto the separation column. Thus, the flow which is delivered during this phase contributes to the volume employed for loading of the sample onto the separation column. The equilibration pump 12 continues to deliver the gradient start conditions until the column distribution valve 13 switches. Thus, the separation column fluidly connected to the equilibration pump 12 is advantageously conditioned to the desired parameters for start of the gradient run. After switching, the equilibration pump 12 is going to start conditioning the other column that previously has been subjected to the gradient. For this, it may be operated in a flow-controlled or pressure-controlled mode.

Meanwhile, the gradient pump 1 may continue to deliver the gradient. Once this phase is completed it may start aligning its pressure to prepare for the gradient start conditions for the next separation column which is currently subjected to flow by the equilibration pump 12. This step takes place in the phase align_{grad} (see FIGS. 3D-3F)) which starts after the beginning of align_{eq}. Simultaneously, the fluidic conduit 4 between pump outlet of the gradient pump 1 and the column distribution valve 13 (see FIG. 1) may be flushed to assure that it contains the correct solvent composition % B start. For the pressure alignment the pump may preferably operate in a pressure-controlled mode, i.e., an operation mode that maintains a constant pressure. For this purpose, the column pressure of the equilibrated column P_{target}, grad may be determined. It should be noted that the equilibration pump has reached its target pressure P_{target,eq} at this point of time. P_{target}, grad may be obtained by a readout of a pressure sensor of the equilibration pump 12 and additionally taking a fluidic resistance between pump outlet of the equilibration pump 12 and the column distribution valve 13 into account. That is, the column pressure of the equilibrated column P_{target}, grad to which the gradient pump may be set, may be based on the target pressure P_{target}, eq of the equilibration pump corrected for the contribution to the backpressure originating from the fluidic resistance of the fluidic connection between the outlet of the second pump and the column distribution valve. Thereby, the pressures of both columns may be (nearly) identical and the just equilibrated column is conditioned such that its pressure level represents the gradient start conditions at which it is going to be operated after switching of the column valve. However, it will be understood that the flow f_{align} provided by the gradient pump at P_{target}, grad may generally be different to the gradient flow f_{grad} provided by the equilibration pump at P_{target,eq}. After completion of the phase align_{grad} the pump may continue to deliver the gradient for the next sample run. To this, it is switched again to a flow-controlled mode.

In the example depicted in FIG. 3F, f_{grad} is higher than f_{align}. This corresponds to a configuration wherein the column currently subjected to a flow of the gradient pump has a lower flow resistance compared to the column that is subjected to flow of the equilibration pump. This difference serves to reaching the aim of having (nearly) identical pressure at both columns prior to switching of the column valve. If the difference in backpressure would be vice versa (or if the columns would be switched) f_{align} would of course be higher than f_{grad}.

That is, the pressure of the gradient pump 1 may be set such that it matches the pressure required for providing the gradient flow rate to the column currently fluidly connected to the equilibration pump 12. By further setting the equilibration pump 12 to provide the gradient flow rate, pressure changes that may otherwise appear when switching between columns may be reduced, preferably minimized, or even completely avoided.

In other words, the present invention provides a method which allows to align the pressure between two separation columns prior to switching a gradient pump from one separation column to the other, thereby at least reducing if not preventing pressure changes that could impair analytical results.

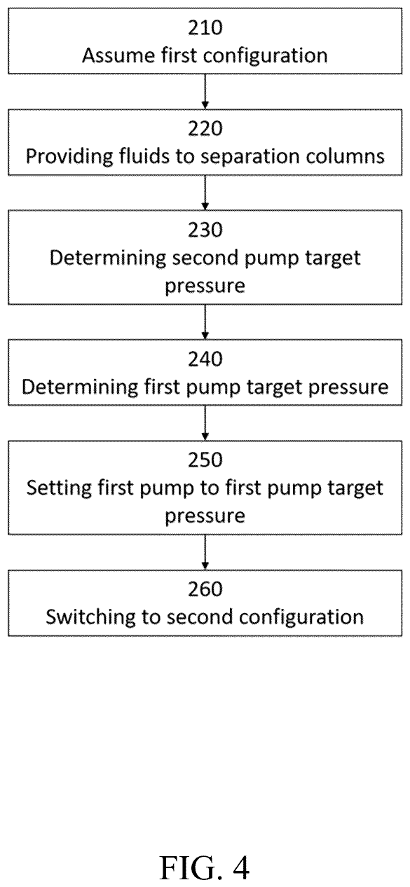

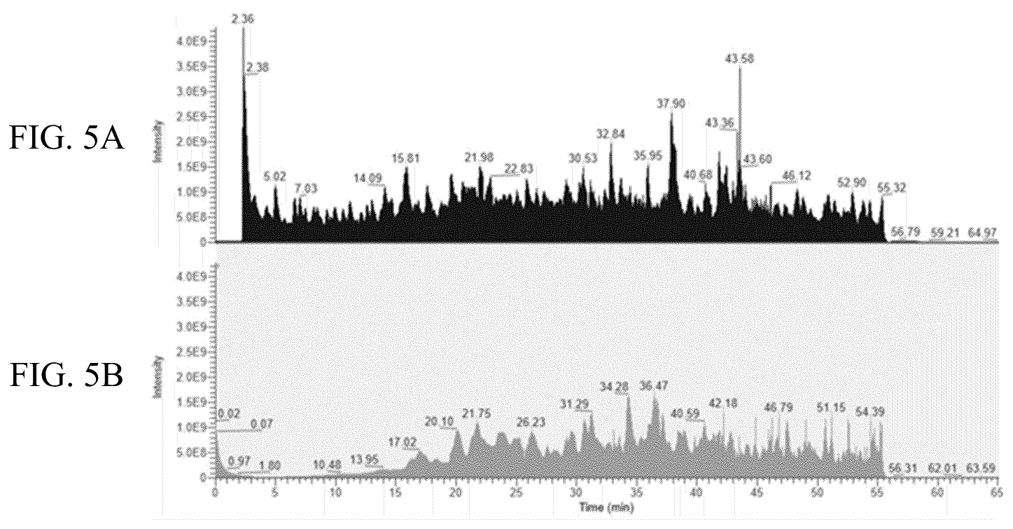

The method according to the present invention is further discussed with reference to FIG. 4. Very generally the present method provides for operating a chromatography system comprising a first pump 1, a second pump 12, a first separation column 8, and a second separation column 5. The system may be configured to selectively provide fluidic connection between pumps and separation columns. For example, the system may be a system as discussed with reference to FIG. 1.

In a first step 210, the system may assume a first configuration, wherein the first pump 1 is fluidly connected to the first separation column 8 and the second pump 12 is fluidly connected to the second separation column 5, e.g., by means of a column distribution valve 13. While assuming this configuration, the method further comprises the first and second pump 1, 12 each providing a fluid to the respective separation column 5, 8 (step 220). In particular, the first pump may provide a fluid to the first separation column 8, and the second pump 12 may provide a fluid to the second separation column 5.

Furthermore, the method comprises determining a second pump target pressure while still in the first configuration (step 230). That is, a target pressure of the second pump 12 (or equilibration pump 12) may be determined, e.g., P_{target,eq} in the above example. This pressure may typically be chosen, such that a desired flow rate is provided to the second separation column 5. The desired flow rate may be a gradient flow rate desired for a subsequent analysis of a sample previously loaded to the second separation column 5, e.g. f_{grad} in the above example. For example, the second pump 12 may be operated in a flow-controlled mode and set to provide the desired flow rate.

Alternatively, the second pump 12 may be operated in a pressure-controlled mode. Particularly, the second pump 12 may be switched into a pressure-controlled mode. The target pressure may then be calculated based on a fluidic resistance or respectively a backpressure of the second separation column and the fluidic connection between the second pump 12 and an inlet to the second separation column 5, which may also be referred to as second pump backpressure as it is experienced at the outlet of the second pump. The second pump backpressure may be determined as the ratio of a current pressure and flow rate present at the second pump 12 prior to changing pressure and/or flow rate of the second pump during determining of the second pump target pressure. Said current pressure and flow rate may for example correspond to flow rate and pressure during or preferably at the end of sample loading. The calculated target pressure of the second pump may then be given by the product of the second pump backpressure and the desired flow rate, e.g. P_{target,eq}=R_{eq}*f_{grad} in the above example, wherein R_{eq}=P_{eq}/f_{eq}. Thus, the second pump may be set to provide the calculated target pressure and once it has been reached switched back to flow-controlled mode to provide the desired flow rate f_{grad}. Operating the second pump in pressure-controlled mode for setting the second pump to provide the desired flow rate may advantageously be faster than simply operating the pump in flow-controlled mode.

Once the desired flow rate has been established either by directly setting it or though first estimating the target pressure, the second pump target pressure may be determined by measuring the pressure at the second pump 12, particularly at an outlet of the second pump 12. Alternatively, the second pump target pressure may be determined as the calculated target pressure, however, the measured second pump target pressure may advantageously be more precise than the calculated target pressure.

Subsequently a first pump target pressure may be determined based on the second pump target pressure (step 240). Typically, there may be a difference in fluidic resistance between the fluidic connection of the second pump 12 to the second separation column 5 in the first configuration and the fluidic connection of the first pump 1 to the second separation column 5 in the second configuration. For example, the fluidic connection between the second pump 12 and the second separation column 5 may (at least partially) comprise the autosampler, which may impose some fluidic resistance and thus contribute to the second pump backpressure. Thus, when aiming to avoid pressure changes at the second separation column while switching from the first configuration to the second configuration, this contribution should be deducted from the second pump target pressure.

Therefore, determining the first pump target pressure may further be based on a difference in fluidic resistance (and thus respective backpressure) between the second pump and the second separation column in the first configuration, and the first pump and the second separation column in the second configuration. It will be understood that generally a fluidic resistance always results in an associated backpressure and that any backpressure thus originates from a fluidic resistance.

However, since the fluidic resistance of the fluidic connection that is unique to the first pump 1 may typically be negligible (as it may only be a short fluidic conduit), its contribution may be neglected for simplicity. A fluidic connection being unique to a pump denotes that the fluidic connection to the respective pump is independent of the configuration assumed by the system. For example, with reference to FIG. 1, the fluidic connection unique to the second pump 1 is fluidic conduit 4. Thus, determining the pump target pressure may alternatively further be based on a fluidic resistance of the fluidic connection unique to the second pump 12. That is, the fluidic resistance of the fluidic connection downstream of the second pump 12 that is independent of whether the system is in the first or second configuration. With reference to the exemplary system in FIG. 1 this would be the fluidic connection between the second pump 12 and the column distribution valve 13 as this is connected to the second pump 12 independent of the configuration assumed by the column distribution valve 13 and thus independent of whether the system assumes the first or second configuration. Thus, the unique fluidic connection of the second pump 12 would comprise fluidic conduits 9, 11 and injection valve 10 of the autosampler 3.

Thus, the first pump target pressure may be determined as a difference of the second pump target pressure and the backpressure originating from the fluidic resistance of the fluidic connection unique to the second pump. In other words, the first pump target pressure may be determined as a difference of the second pump target pressure and the backpressure originating from the fluidic connection downstream of the second pump that is independent of whether the system is in the first or second configuration

Once determined, the first pump 1 may be set to provide fluid at the first pump target pressure (step 250), preferably the fluid has a desired fluid composition for sample analysis. In particular, the desired fluid composition may correspond to the solvent composition desired for a start of the gradient provided by the first pump 1, e.g., % Bₛₜₐᵣₜ for the above example. Furthermore, the second pump 12 may continue to supply fluid at the second pump target pressure. Preferably, also the fluid provided by the second pump 12 has the desired target composition. Thus, both pumps may supply fluid at very similar pressure, wherein the pressures are chosen such that upon switching the configuration assumed by the system, the first pump 1 provides fluid to the second separation column 5 at the desired flow rate in the second configuration and further such that there is no significant pressure change at the inlet of the second separation column 5 when switching from the first to the second configuration. The term “no particular pressure change” refers to a relative pressure change at the inlet of the second separation column being less than 10%, preferably less than 5% more preferably less than 1%.

It will be understood that the second pump target pressure is preferably determined for the desired fluid composition. That is, the desired fluid composition may already be provided by the second pump 12 when determining the second pump target pressure and particularly when determining the second pump backpressure.

Similarly, the second separation column 5 may preferably be operated at a desired temperature when determining the second pump target pressure. Furthermore, the first separation column 8 may preferably be operated at the desired temperature when setting the first pump 1 to the first pump target pressure. The desired temperature may be the temperature desired for a subsequent gradient run.

The advantage of aligning the pressure at the separation columns prior to switching can be seen in FIGS. 5A-5B, which show two chromatograms. These chromatograms are total ion current chromatograms based on respective MS analyses of the effluent of in a tandem chromatography system. That is, for each retention time all signals across the whole detected range of mass-to-charge ratios (m/z) are summed up to provide the respective total ion current. Both chromatograms have been recorded under comparable conditions (apart from the pressure adjustment according to the present invention). FIG. 5A) depicts a chromatogram recorded utilizing the present invention to align the pressures at the separation columns prior to switching, whereas FIG. 5B) depicts a chromatogram recorded without such a pressure alignment. While in panel A) the first signal starts at about 2 minutes, the initial signal in panel B) is already present at 0 min and thus shows clear indications of early eluting compounds that are no longer fully captured by the chromatogram. In fact, most of the initial signal peak of panel B) was not even recorded. Furthermore, the small amount of signal following the initial signal peak in panel B) compared to panel A) further evidences the wash-off of compounds as a result of the pressure jump. In other words, without prior pressure alignment between the separation columns the resulting pressure change during switching the gradient pump to the separation column to be analysed result in wash-off of early eluting compounds. This may result in a loss of valuable information, and consequently render the analysis result significantly less useful.

This clearly shows the advantages of the present invention, which allows to account for any difference in pressure between the two separation columns, e.g., also for column aging, for which the actual effect on the backpressure is often not precisely known. Thus, the present invention advantageously allows for an enhanced quality of the analytical results, particularly owing to an enhanced precision of the measured retention time as well as an enhanced life time of the separation columns, which can be damaged and/or experienced increased wear to due to otherwise occurring pressure changes.

It should be recognized that embodiments of the present invention can be implemented via computer hardware, a combination of both hardware and software, or by computer instructions stored in a non-transitory computer-readable memory. The methods can be implemented in computer programs using standard programming techniques-including a non-transitory computer-readable storage medium configured with a computer program, where the storage medium so configured causes a computer to operate in a specific and predefined manner-according to the methods and figures described in this Specification. Each program may be implemented in a high-level procedural or object-oriented programming language to communicate with a computer system. However, the programs can be implemented in assembly or machine language, if desired. In any case, the language can be a compiled or interpreted language. Moreover, the program can run on dedicated integrated circuits programmed for that purpose.

Further, methodologies may be implemented in any type of computing platform, including but not limited to, personal computers, mini-computers, main-frames, workstations, networked or distributed computing environments, computer platforms separate, integral to, or in communication with charged particle tools or other imaging devices, and the like. Aspects of the present invention may be implemented in machine readable code stored on a non-transitory storage medium or device, whether removable or integral to the computing platform, such as a hard disc, optical read and/or write storage mediums, RAM, ROM, and the like, so that it is readable by a programmable computer, for configuring and operating the computer when the storage media or device is read by the computer to perform the procedures described herein. Moreover, machine-readable code, or portions thereof, may be transmitted over a wired or wireless network. The invention described herein includes these and other various types of non-transitory computer-readable storage media when such media contain instructions or programs for implementing the steps described above in conjunction with a microprocessor or other data processor. The invention also includes the computer itself when programmed according to the methods and techniques described herein.

Computer programs can be applied to input data to perform the functions described herein and thereby transform the input data to generate output data. The output information is applied to one or more output devices such as a display monitor. In preferred embodiments of the present invention, the transformed data represents physical and tangible objects, including producing a particular visual depiction of the physical and tangible objects on a display.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

We claim:

1. A method for operating a chromatography system, the method comprising:
the system assuming a first configuration, wherein
a first pump is fluidly connected to a first separation column; and
a second pump is fluidly connected to a second separation column;
in the first configuration:
the first pump providing a fluid to the first separation column;
the second pump providing a fluid to the second separation column;
determining a second pump target pressure;
determining a first pump target pressure based on the second pump target pressure; and
setting the first pump to provide fluid at the first pump target pressure;
the method further comprising:
the system switching to a second configuration, wherein the first pump is fluidly connected to the second separation column, while the first pump provides fluid at the first pump target pressure.

2. The method of claim 1, wherein the second pump target pressure is determined based on a desired flow rate.

3. The method of claim 2, wherein the second pump target pressure is determined such that in the first configuration the second pump supplies a fluid across the second separation column at the desired flow rate when the second pump target pressure is present at the second pump.

4. The method of claim 2, wherein determining the second pump target pressure comprises measuring the pressure present at the second pump when providing the desired flow rate, wherein the second pump target pressure is determined to correspond to the measured pressure.

5. The method of claim 1, wherein the method further comprises setting the second pump to provide fluid at the second pump target pressure in the first configuration.

6. The method of claim 1, wherein determining the first pump target pressure is further based on a fluidic resistance of a fluidic connection downstream of the second pump that is independent of whether the system is in the first or second configuration.

7. The method of claim 1, wherein the first pump target pressure is determined such that when the first pump target pressure is present at the first pump while providing a fluid to the second separation column, a pressure at an inlet of the second separation column is substantially equal to the pressure at the inlet of the second separation column when supplying the same fluid with the second pump at the second pump target pressure.

8. The method of claim 1, wherein a relative pressure change at an inlet of the second separation column when the system switches from the first to the second configuration is less than 10%.

9. A chromatography system, comprising:
a first pump;
a second pump;
a first separation column; and
a second separation column;
wherein the system is configured to assume a first configuration, wherein
the first pump is fluidly connected to the first separation column; and
the second pump is fluidly connected to the second separation column;
wherein the system is configured to assume a second configuration wherein the first pump is fluidly connected to the second separation column; and
wherein the system further comprises a controller configured to perform the method of claim 1.

10. At least one non-transitory computer-readable storage medium comprising computer-executable instructions which, when executed by a computer, cause the computer to carry out the method of claim 1.
